(19) United States
(12) Patent Application Publication
(10) Pub. No.: US 2018/0312133 A1
(43) Pub. Date: Nov. 1, 2018

(54) MOTOR VEHICLE BODY WITH AIRBAG ARRANGEMENT IN THE REGION OF A COWL

(71) Applicant: GM GLOBAL TECHNOLOGY OPERATIONS LLC, Detroit, MI (US)

(72) Inventors: Thomas Jenny, Alsbach-Haehnlein (DE); Oliver Scherf, Bessenbach (DE)

(73) Assignee: GM GLOBAL TECHNOLOGY OPERATIONS LLC, Detroit, MI (US)

(21) Appl. No.: 15/963,643

(22) Filed: Apr. 26, 2018

(30) Foreign Application Priority Data
Apr. 26, 2017 (DE) 102017004044.3

(51) Int. Cl. B60R 21/38; B60R 21/36

(52) U.S. Cl. CPC B60R 21/38; B60R 2021/0004; B60R 21/36

(57) ABSTRACT

A motor vehicle body includes a hood, a cowl and at least one airbag arrangement. The cowl borders on a windshield of the motor vehicle body from outside and is at least partially located underneath an end of the hood. The airbag arrangement includes a housing, which is arranged underneath an end of the hood in an intermediate space therebetween. In case of a collision with a pedestrian, the airbag arrangement can be triggered and at least slightly raise the hood at a rear end opposite from the driving direction.

### CROSS-REFERENCE TO RELATED APPLICATION

This application claims priority to German Patent Application No. 102017004044.3, filed Apr. 26, 2017, which is incorporated herein by reference in its entirety.

### TECHNICAL FIELD

The present disclosure pertains to a motor vehicle body, particularly to a passenger car, with a cowl arranged in front of a windshield and with at least one airbag arrangement provided on or in the region of the cowl.

### BACKGROUND

Passenger cars nowadays feature special measures and devices for protecting pedestrians. With respect to passenger cars, one such device absorbs or dissipates the impact energy caused by a collision with a pedestrian as gently as possible.

Such pedestrian protection measures are particularly provided in the front region of the motor vehicle, e.g. in the region of a hood that is arranged in front of a windshield referred to the driving direction of the motor vehicle. In order to realize an effective passenger protection, it may be advantageous to at least slightly raise a rear end of the hood adjacent the windshield referred to the vertical vehicle axis in case of a collision in order to thereby provide sufficient deformation space for energy absorption. These corresponding measures prove to be comparatively complex and elaborate, particularly in the region of a hood hinge.

### SUMMARY

The present disclosure provides a motor vehicle body that is improved in this respect and involves a reduced risk of injuries to pedestrians in case of a collision. The motor vehicle body can be manufactured in a particularly simple and rational fashion and realized with hood hinges that have a very simple and therefore cost-efficient design.

In an embodiment, a motor vehicle body includes a hood, a cowl and at least one airbag arrangement. The cowl borders on a windshield of the motor vehicle body from outside. With reference to the vertical vehicle axis (z), the cowl is at least partially located underneath an end of the hood away from the driving direction (i.e. the forward direction of travel). The airbag arrangement features a housing, which is located between the hood and the cowl, and more particularly arranged underneath an end of the hood that faces away from the driving direction and therefore in the intermediate space between the hood and the cowl. In case of a collision with a pedestrian, the airbag arrangement can be triggered and thereby at least slightly raise the hood, particularly at its rear end opposite from the driving direction. In this way, sufficient deformation space for the absorption of impact energies can be provided and effective pedestrian protection can be achieved.

In this case, the airbag arrangement is located in the exterior region of the motor vehicle in front of the windshield referred to the driving direction of the motor vehicle. It is also located outside the engine compartment of the motor vehicle in the intermediate space between the cowl and the rear end of the hood.

Due to the utilization of the airbag arrangement, it is no longer required to provide separate actuators in the region of the hood hinge or hood hinges. In this way, the hood hinges can be manufactured and designed much more cost-efficiently. Airbag arrangements are commercially available in many different designs and can be adapted to the intended use proposed herein with slight modifications.

According to an embodiment, the motor vehicle body features at least one left and one right airbag arrangement. The left and the right airbag arrangements are arranged directly adjacent to a left hood hinge and a right hood hinge, respectively. The left airbag arrangement is arranged directly adjacent to a left hood hinge. The right airbag arrangement is accordingly arranged directly adjacent to a right hood hinge. The arrangement of the airbag arrangements directly adjacent to the respective hood hinges makes it possible to suspend the actual hinge function of the hood hinges and to initiate an opening motion of the hood in the region of the hood hinges as needed.

The airbag arrangements, which are arranged in the immediate vicinity of the hood hinges, make it possible to apply a force to the hood in the immediate vicinity of the hood hinges. In this way, a force that exceeds a threshold value can be exerted upon the hood hinges via the hood such that these hood hinges can be transferred into a collision position or collision configuration.

According to another embodiment, the motor vehicle body is furthermore equipped with at least one reinforcement member, which is provided on the side of the airbag arrangement facing away from the hood. A separate reinforcement member is typically provided for each airbag arrangement. The reinforcement member serves for absorbing the forces caused by the deployment of the airbag arrangement. The reinforcement member particularly serves as an abutment of sorts for the respective airbag arrangement. The reinforcement member may be realized in the form of a reinforcing or reaction plate, on which a force acting thereupon due to the deployment of the airbag arrangement can be supported. In this respect, a reaction force that transfers the hood into a collision position originates from the reinforcement member, which is fixedly arranged on the vehicle body, when the airbag arrangement acts upon the reinforcement member due to the deployment of its airbag.

According to another embodiment, the motor vehicle body features an upper cover and a lower cover for the cowl. The upper and the lower cover may be arranged on and at least partially overlaps the cowl. The cowl is typically realized in the form of a formed sheet metal part, for example a stamped and/or die-cut metal sheet. The upper and/or the lower cover may be realized in the form of molded plastic parts. The cowl may feature, for example, a channel for water flowing off the windshield, which extends in the lateral vehicle direction (y) transverse to the driving direction. This channel can generally also be referred to as a water box or water channel.

The reinforcement member may likewise be arranged on the cowl such that it overlaps or at least partially overlaps at least one of the two covers. In order to achieve an optimal force transmission or to optimally make available an opposing force or reaction forces, the reinforcement member may be structurally connected to the cowl itself, i.e. to the part of the cowl realized in the form of a metal sheet.

According to another embodiment, the reinforcement member is arranged on the cowl or integrated into the cowl. With respect to the functionality of the airbag arrangement, it suffices if the reinforcement member is integrated into a one-piece cowl. For example, the cowl may feature structurally reinforced regions that ultimately lie directly adjacent to the airbag arrangement. The reinforcement member may thus be integrated into the cowl, for example, in the form of a metal insert. However, it may also be mounted on the cowl in the form of a separate component.

According to another embodiment, the reinforcement member is arranged between the upper cover and the lower cover or on an upper side of the upper cover. In either arrangement, it is proposed that the reinforcement member is arranged above the actual cowl, particularly above the metallic cowl, referred to the vertical vehicle axis (z). In this way, a sufficient force transmission can be achieved or a reaction force can be sufficiently made available.

According to another embodiment, the reinforcement member features a reinforcing plate that is structurally connected to the cowl. The reinforcing plate may be provided with one or more through-openings. In this respect, the reinforcing plate may be arranged in the exterior region of the motor vehicle. In this case, the through-openings act as drainage openings for water accumulating in the region of the cowl.

The reinforcing plate may feature one or more stampings. In this way, a reinforcing plate with a low weight and a comparatively small material thickness can be realized in a relatively stable and torsion-proof fashion.

According to another embodiment, the reinforcement member or the reinforcing plate is respectively integrated into the housing of the airbag arrangement. If the reinforcement member is integrated into the housing, a separate installation of the reinforcement member on the cowl or on the motor vehicle body is eliminated. The integration of the reinforcement member into the housing of the airbag arrangement thereby simplifies the installation process. Furthermore, the overall number of components can thereby be reduced.

According to another embodiment, the airbag arrangement is arranged on an underside of the hood. For example, the hood may feature an outer panel and an inner panel. In this case, the airbag arrangement is arranged on the inner panel of the hood. In any embodiment, the reinforcement member may either be integrated into an underside of the housing of the airbag arrangement or mounted on the motor vehicle body at a section of the cowl that faces the airbag arrangement in the form of a separate reinforcement member.

According to another embodiment, the airbag arrangement with the reinforcement member is arranged on the cowl. In this case, the reinforcement member, as well as the airbag arrangement, is directly mounted on the cowl. It is possible to arrange the reinforcement member on the cowl and to subsequently mount the airbag arrangement on the reinforcement member mounted on the cowl. However, it is also possible to mount the airbag arrangement and the reinforcement member on the cowl by common mounting points. If the reinforcement member is integrated into the airbag arrangement, the airbag arrangement may be merely mounted on the cowl.

A mutual installation and orientation of the reinforcement member and the airbag arrangement can be simplified by making available predefined mounting points on the cowl, the reinforcement member and/or the airbag arrangement.

According to another embodiment, the airbag arrangement is arranged on the cowl together with the reinforcement member. In this respect, a structurally reinforced region may be provided on the underside of the hood or on the inner panel of the hood. The airbag of the airbag arrangement being deployed presses against this structurally reinforced region and thereby pushes against the hood from below.

According to another embodiment, the housing of the airbag arrangement features an elastic wall section. If the airbag arrangement is arranged on the cowl, the elastic wall section may be configured to face the hood. If the airbag arrangement is arranged on the inner panel or on the underside of the hood, the elastic wall section may be configured to face the cowl. The airbag being deployed can thereby cause the housing of the airbag to at least temporarily buckle or bulge. In this way, a force that raises the hood or a corresponding opening momentum can be exerted upon the hood in a comparatively early phase of the airbag deployment. In this context, it is typically intended that the elastic wall section presses against the reinforcement member due to an airbag deployment and thereby causes the hood to be raised into a collision position.

According to another embodiment, the housing of the airbag arrangement may feature an opening in the direction toward the windshield. This opening defines a deployment direction of the airbag in case it is triggered. The airbag being deployed can expand in the direction of the windshield and thereby dampen an impact of the pedestrian on the windshield or on its transition area into the hood.

According to another embodiment, the inner side of the hood or an inner panel of the hood is provided with an essentially plane reinforcement member, which ultimately lies directly above the airbag arrangement referred to the vertical vehicle axis (z) when the hood is closed. The reinforcement member can make available a comparatively homogenous force absorption surface over the area that is acted upon by the airbag being deployed. In addition, a comparatively high force can be introduced from the airbag into the hood over a comparatively large area. This can advantageously affect the process of raising one or more hood hinges or transferring the hood hinges into a raised collision position.

According to another aspect, the present disclosure ultimately also proposes a motor vehicle, particularly in the form of a passenger car, with at least an above-described motor vehicle body.

### BRIEF DESCRIPTION OF THE DRAWINGS

The present disclosure will hereinafter be described in conjunction with the following drawing figures, wherein like numerals denote like elements.

FIG. 1 shows a schematic side view of a motor vehicle;

FIG. 2 shows an exploded view of the cowl, the upper cover, the lower cover and reinforcement members;

FIG. 3 shows an assembly configuration of the cowl and the lower cover;

FIG. 4 shows an arrangement according to FIG. 3, however, with reinforcement members arranged thereon;

FIG. 5 shows the arrangement according to FIG. 4, in which the upper cover is arranged above the reinforcement members;

FIG. 6 shows a configuration that differs from FIG. 5, in which the reinforcement members are arranged between the upper and the lower cover;

FIG. 7 shows a cross section through the arrangement shown in FIG. 6 along the line A-A;

FIG. 8 shows a schematic representation of a hood hinge in a partially open position;

FIG. 9 shows a schematic representation of the hood hinge in a collision position;

FIG. 10 shows a detail of FIG. 7 prior to the deployment of the airbag;

FIG. 11 shows a cross section according to FIG. 10 shortly after the beginning of the deployment of the airbag;

FIG. 12 shows a cross section according to FIG. 11 during the further deployment of the airbag;

FIG. 13 shows an exploded view of the airbag arrangement and the reinforcement member;

FIG. 14 shows another cross section through the cowl, in which the airbag arrangement is arranged in a receptacle shaft on the underside of the hood;

FIG. 15 shows a detail of FIG. 14 prior to the deployment of the airbag;

FIG. 16 shows a cross section according to FIG. 15 shortly after the beginning of the deployment of the airbag;

FIG. 17 shows a cross section according to FIG. 16 during the further deployment of the airbag;

FIG. 18 shows an exploded view of the components shown in FIGS. 14-17;

FIG. 19 shows a perspective view of FIG. 18 in the assembly configuration;

FIG. 20 shows a cross section through the cowl, in which the airbag arrangement is arranged on the cowl;

FIG. 21 shows a detail of FIG. 20 prior to the deployment of the airbag;

FIG. 22 shows a cross section according to FIG. 20 shortly after the beginning of the deployment of the airbag;

FIG. 23 shows a cross section similar to FIG. 22 during the further deployment of the airbag;

FIG. 24 shows an exploded view of the components arranged in the region of the cowl;

FIG. 25 shows a design variation of the reinforcement member shown in FIG. 24;

FIG. 26 shows a perspective view of the components illustrated in FIG. 24 in the assembly configuration;

FIG. 27 shows another embodiment of the cowl with integrated reinforcement members;

FIG. 28 shows another embodiment of the cowl with reinforcement members arranged thereon;

FIG. 29 shows an interior view of the hood according to an embodiment; and

FIG. 30 shows another interior view of the hood according to another embodiment.

### DETAILED DESCRIPTION

The following detailed description is merely exemplary in nature and is not intended to limit the invention or the application and uses of the invention. Furthermore, there is no intention to be bound by any theory presented in the preceding background of the invention or the following detailed description.

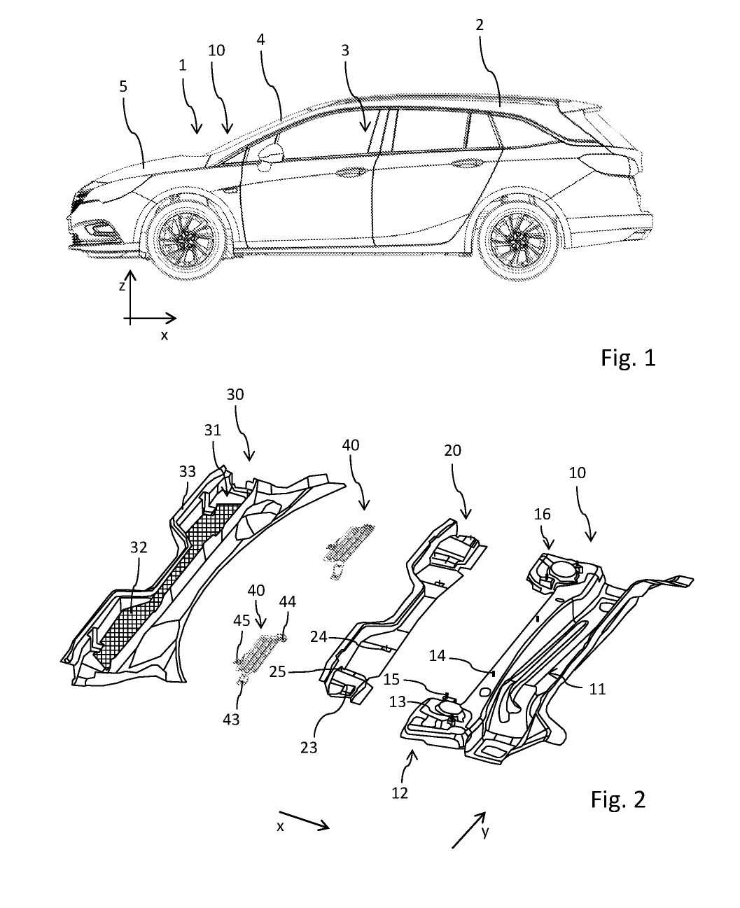

The motor vehicle 1, which is illustrated in the form of a schematic side view in FIG. 1, features a self-supporting motor vehicle body 2 with an interior 3 that serves as a passenger compartment. The interior 3 is defined by a windshield 4 in the driving direction of the motor vehicle. A hood 5 is located in front of the windshield referred to the driving direction. A cowl 10, which is illustrated separately in FIG. 2, is provided on the vehicle body in the transition area from the hood 5 into the windshield 4.

The cowl 10 may be realized in the form of a formed metal part. It may be manufactured, for example, of a metal sheet. It may particularly feature a channel section 11 that extends in the lateral vehicle direction (y). In front of the channel section 11, the cowl respectively features covers 12, 16 for the presently not-shown suspension strut domes of the vehicle body 2 on a left and a right outer side. The covers 12, 16 at least slightly protrude forward in the driving direction from the channel section 11.

The region between the covers 12, 16 can be covered with a lower cover 20, which is realized in the form of a separate component. The lower cover 20 may consist of a plastic part, particularly a molded plastic part.

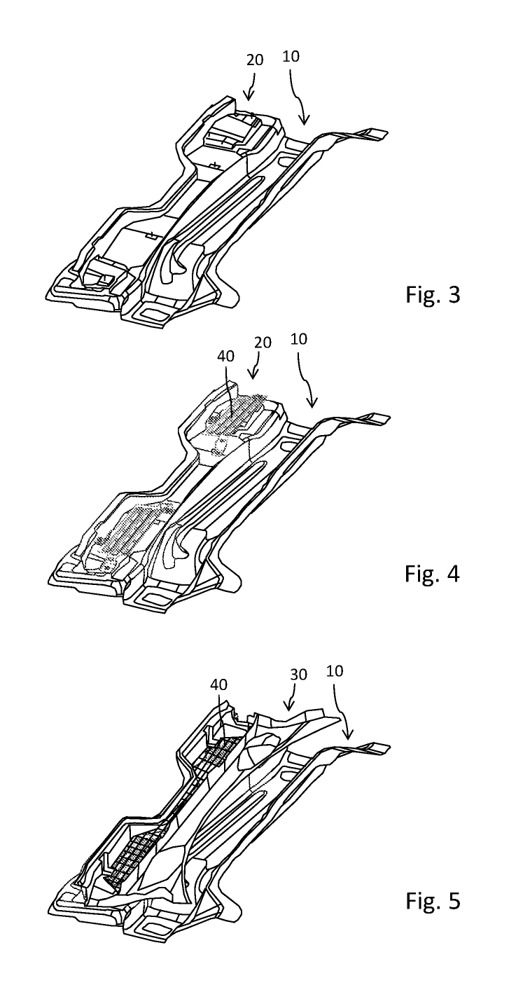

The cowl 10 may furthermore be provided with an upper cover 30 that can be arranged on the cowl 10 above the lower cover 20. The assembly sequence can be gathered from FIGS. 3-5. In FIG. 3, only the lower cover 20 is arranged on the cowl 10. In FIG. 4, two reinforcement members 40, namely a left reinforcement member and a right reinforcement member 40, are furthermore arranged above the lower cover 20 in a region that overlaps the covers 12, 16 of the cowl 10.

FIG. 5 shows the entire arrangement according to FIG. 4 with the upper cover 30. The upper cover 30 may also include a plastic part like the lower cover 20. It may be realized in the form of a molded plastic part, for example an injection-molded plastic part. The upper cover 30 may particularly feature one or more leaf collecting screens 32.

The motor vehicle body 2 is furthermore equipped with at least one airbag arrangement 60 that is schematically illustrated in the cross section according to FIG. 7. The airbag arrangement 60 features a housing 61 and an airbag 62 arranged in the housing. The airbag 62 can be triggered, for example, in case of a collision with a pedestrian or with other coalition partners and thereby deploy as intended.

The airbag arrangement 60 is typically arranged above the reinforcement member 40, which features a reinforcing plate, referred to the vertical vehicle axis (z). In the embodiment according to FIG. 7, the airbag arrangement 60 is arranged on the underside of the hood 5. In other embodiments, the airbag arrangement 60 is directly installed and mounted on the cowl 10 or on the reinforcement member 40, respectively.

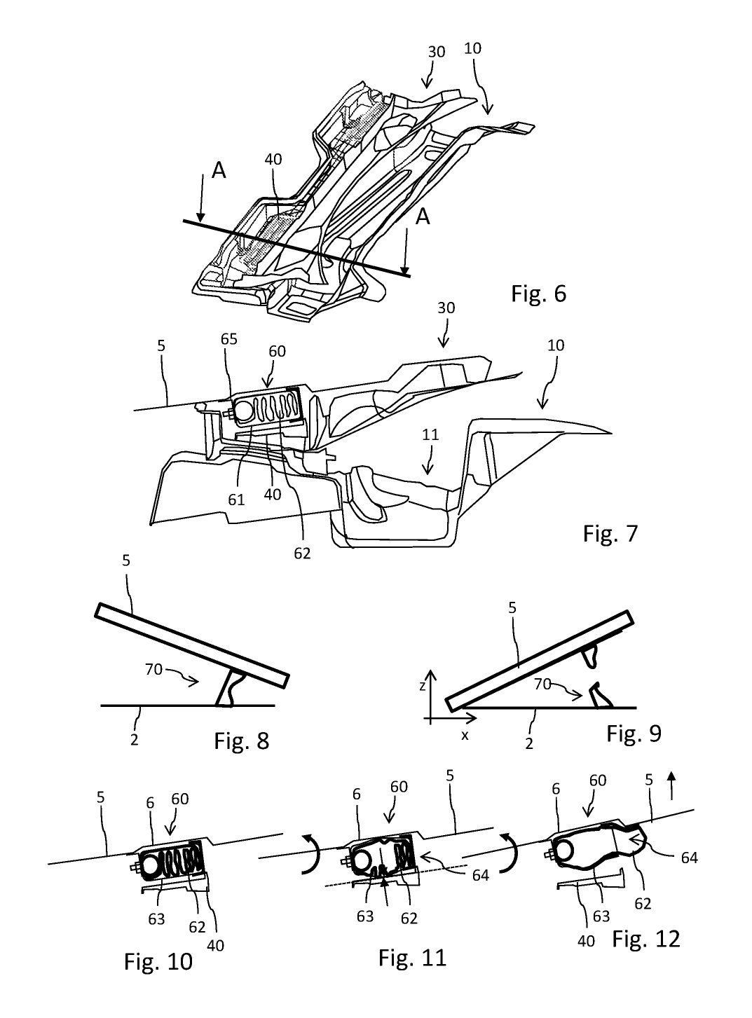

The motor vehicle body 2 is typically provided with a left airbag arrangement 60 and a right airbag arrangement 60, which are respectively arranged above a left reinforcement member 40 and a right reinforcement member 40 as illustrated in FIG. 2. The reinforcement members 40, which feature a corrugated or stamped reinforcing plate 41, act as an abutment for the airbag being deployed. In the exemplary embodiment according to FIGS. 6 and 7, the airbag arrangement 60 is arranged on the underside of the hood 5.

The airbag arrangements 60 are respectively arranged in the immediate vicinity of a hood hinge with respect to the longitudinal vehicle axis (x) and with respect to the lateral vehicle axis (y). The hood hinge 70 is schematically illustrated in FIG. 8. The hood 5 can be transferred from a closed position, in which it is approximately oriented horizontally, into a raised position by means of the hood hinge 70. The hood hinge 70 is typically arranged on a rear end of the hood 5 that faces away from the driving direction. The hood hinge 70 makes it possible to transfer the front region of the hood 5, e.g. the region of the hood 5 that faces the front of the vehicle, into a raised position. In case of a collision, however, it is desirable to separately raise the hood 5 with respect to the vertical vehicle axis (z) in the region of the hood hinge. This is respectively achieved with the airbag 62 of the airbag arrangement 60 or the airbag arrangement 60 being deployed.

The hood hinge 70 may feature a predetermined breaking point of sorts that ruptures when a force that exceeds a predefined limiting value acts upon the hood hinge 70 from below such that the hood hinge 70 can be transferred into a collision configuration of the type schematically illustrated in FIG. 9. In this case, the hood hinge 70 may still remain intact, particularly for respectively opening or raising the region of the hood 5 that faces away from the driving direction along the vertical vehicle axis (z).

The deployment of the airbag 62 of the airbag arrangement 60 is sequentially illustrated in FIGS. 10, 11 and 12. FIG. 10 shows the airbag 62 in an initial position. The deployment of the airbag 62 begins in FIG. 11. As a result, an elastic wall section 63 of the housing 61 of the airbag arrangement 60 expands in the direction toward the reinforcement member 40. Due to the impact on the stationary reinforcement member 40, such an elastic deformation of the elastic wall section 63 causes an upwardly directed momentum to be exerted upon the hood 5, which as a result assumes a raised collision position indicated in FIG. 12. After the beginning of its deployment, the airbag 62 starts to deploy through the opening 64 of the housing 61. The opening is located on the end of the housing 61 that faces away from the driving direction and therefore on the end of the housing 61 that faces the windshield 4.

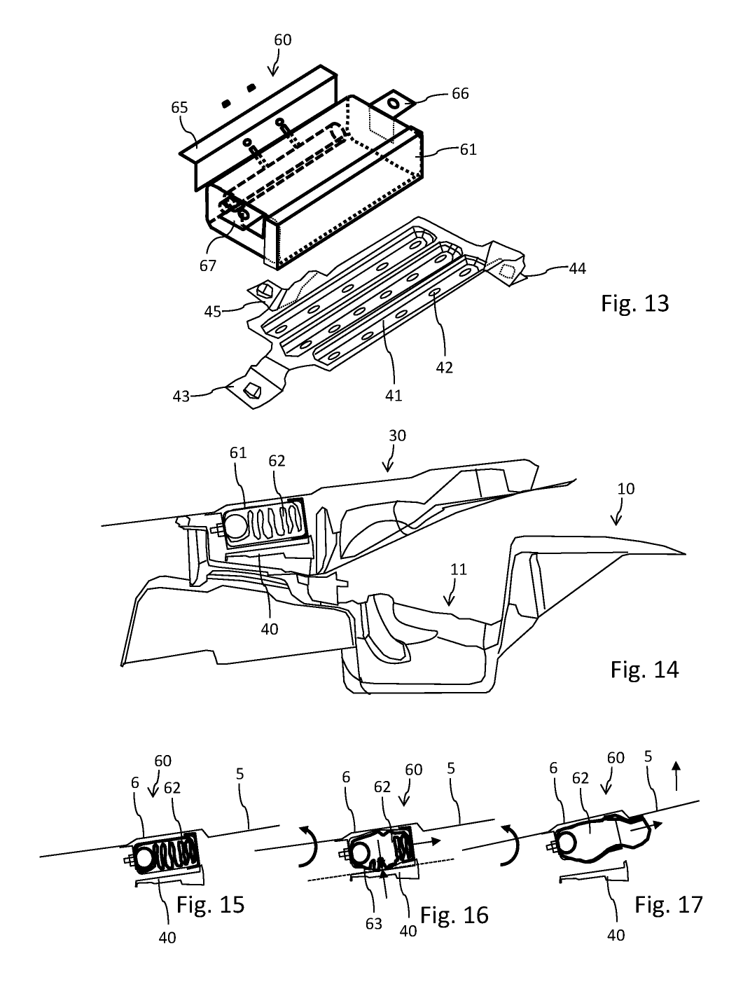

FIG. 13 ultimately shows that the airbag arrangement 60 is arranged on the underside of the hood 5 by means of separate mounting brackets 65, 66, 67. The mounting bracket 65 may extend over the entire width of the housing 61 of the airbag arrangement 60 or over part of its width only. In this case, an upper flange, which is angled forward in the driving direction of the motor vehicle 1, is mounted on the underside of the hood 5 as also illustrated in FIGS. 7 and 10-12.

Furthermore, additional lateral mounting brackets 66, 67 are provided, wherein these additional mounting brackets are arranged on the sidewalls of the housing 61 and make it possible to rigidly fix the housing 61 of the airbag arrangement 60 on the underside of the hood 5. FIG. 13 furthermore shows that the reinforcement member 40 is realized in the form of a reinforcing plate 41 that is stamped, for example, with multiple V-shaped grooves, wherein through-openings 42 that serve as drainage openings are located in said grooves. The reinforcement member 40 altogether features two, three or more mounting points 43, 44, 45 that protrude outward and make it possible to separately mount the reinforcing element 40 on the cowl 10 or on the motor vehicle body 2, respectively.

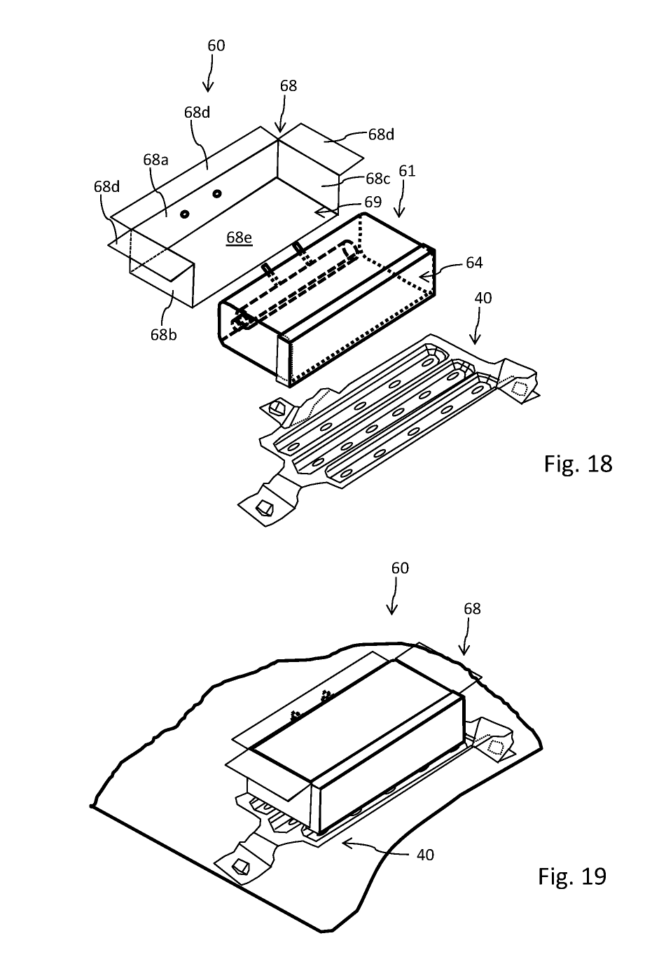

The illustrations in FIGS. 14-18 are analogous to those in FIGS. 7 and 10-13, but differ in that a mounting shaft 68 of the type illustrated separately in FIG. 18 is provided on the underside of the hood 5 in order to mount the airbag arrangement 60. The shaft 68 features a rear wall 68a, two adjacent sidewalls 68b, 68c and a receptacle 69 for the housing 61 of the airbag arrangement 60, which is open opposite to the driving direction. The rear wall 68a and the sidewalls 68b, 68c feature a mounting flange 68d that respectively protrudes outward or forward and makes it possible to mount the shaft 68 on the underside of the hood 5. FIG. 19 ultimately shows a final assembly configuration underneath an imaginary transparent hood 5.

The airbag arrangement 60 is located underneath the reinforcement member 40 referred to the vertical vehicle axis (z). In this case, the housing 61 of the airbag arrangement may feature an elastic wall section 63, which is oriented or arranged such that it faces the reinforcement member 40. During the deployment of the airbag 62, the elastic wall section 63 can yield downward and support itself on the reinforcement member 40 in order to thereby exert an upwardly directed momentum upon the hood 5. A bottom 68e of the shaft 68 may likewise be realized in a flexible fashion in order to allow a deployment of the airbag 62 and the housing 61 in the direction of the reinforcement member 40.

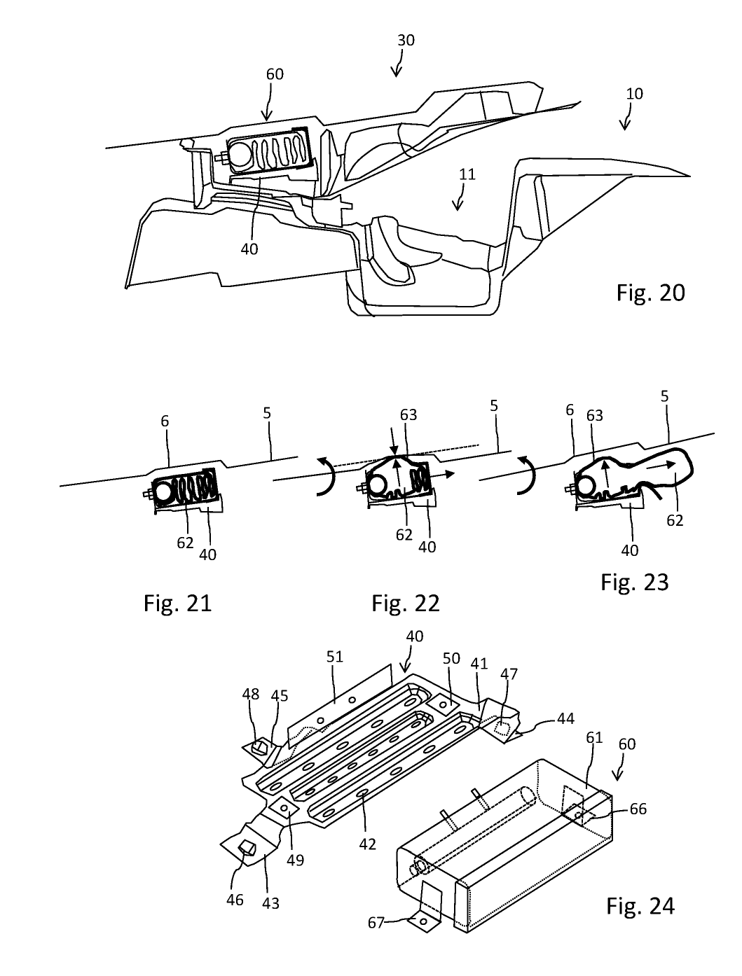

The embodiments according to FIGS. 20-26 can be distinguished from the embodiments according to FIGS. 7-19 in that the airbag arrangement 60 is arranged directly on the cowl 10 together with the reinforcement member 40. The reinforcement member 40 may be arranged on the cowl 10, for example, between the lower cover 20 and the upper cover 30 as illustrated in FIG. 4. The airbag arrangement 60 can then be arranged above the upper cover 30, for example on the upper side 31 of the upper cover 30. However, the reinforcement member 40 may be arranged above the upper cover 30, for example on the upper side 31 of the upper cover 30, as illustrated in FIG. 5 and to thereby mount the reinforcement member on the cowl 10. Individual mounting elements 13, 14, 15 may be provided on the cowl for mounting the reinforcement member 40 on the cowl 10. The mounting elements in FIG. 2 are realized in the form of mounting projections or pins that protrude from the upper side of the cowl 10.

Through-openings 23, 24, 25, which correspond to the position of the mounting elements 13, 14, 15, may be formed in the lower cover 20, wherein the mounting elements 13, 14, 15 extend through these through-openings in the installed position of the lower cover 20 on the cowl 10. The mounting points 43, 44, 45 of the reinforcement members 40 may respectively feature through-openings 46, 47, 48, which correspond to the position of the mounting elements 13, 14, 15 and with which the mounting elements 13, 14, 15 cooperate.

In this way, the lower cover 20, as well as the reinforcement members 40, can be mounted on one and the same mounting structure of the cowl 10. A separate mutual connection between the reinforcement members 40 and the lower cover 20 is therefore not required. In an embodiment, in which the reinforcement members 40 are arranged above the upper cover 40, the mounting elements 13, 14, 15 of the cowl 10 may also respectively extend through a plane or the plastic body of the upper cover 30. For example, the mounting elements 13, 14, 15 may extend through the leaf collecting screen 32 of the upper cover 30 and thereby allow an installation of the reinforcement members 40 on the upper side 31 of the upper cover 30.

In principle, the airbag arrangement 60 may be directly arranged on the mounting elements 13, 14, 15 of the cowl 10. In this respect, such mounting elements 13, 14, 15 may have multiple functions such as arranging and mounting multiple elements, namely the lower cover 20, the reinforcement members 40 and also the airbag arrangement 60. However, the reinforcement members 40 may also be provided with separate mounting elements 49, 50, on which the airbag arrangement 60, particularly its housing 61, can be separately mounted.

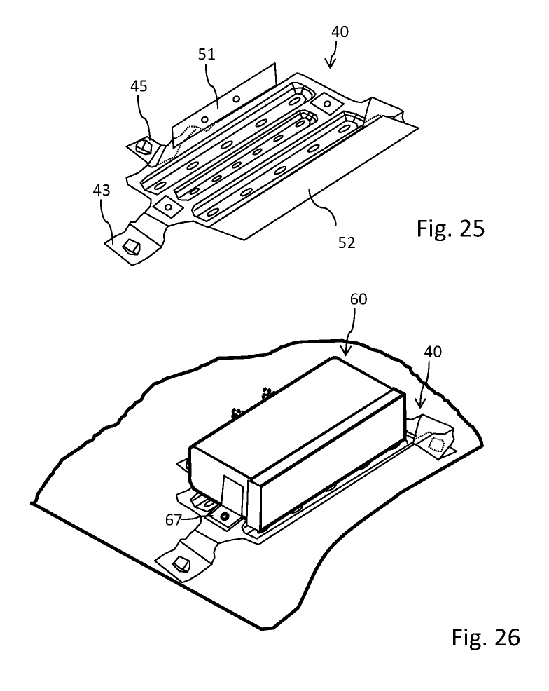

Mounting elements 49, 50 of this type are illustrated, for example, in FIGS. 24 and 25. The reinforcement member 40 may also feature a mounting bracket 51, on which the housing 61 of the airbag arrangement 60 can be mounted, on its front end referred to the driving direction. The embodiment of the reinforcement member 40 according to FIG. 25 furthermore features an extension 52 that is directed opposite to the driving direction and can be regarded as a plane projection of the reinforcing plate 41 opposite to the driving direction. The extension 52 may be folded upward in the final installation position of the airbag arrangement 60 on the cowl 10 or on the reinforcing element 40 and thereby virtually seal an opening 64 of the housing 61 of the airbag arrangement 60.

During the activation and deployment of the airbag 62, the extension 52 can initially provide a certain resistance against the deployment of the airbag 62 opposite to the driving direction such that a downwardly directed deformation and/or bulge of the housing 61 of the airbag arrangement 60 is effected or promoted. This is advantageous for raising the hood 5.

FIGS. 24 and 26 furthermore show that the housing 61 of the airbag arrangement 60 can be mounted on mounting points or mounting elements 49, 50 of the reinforcement member 40, which are provided for this purpose, by means of mounting brackets 66, 67.

FIG. 27 shows another embodiment of the cowl 10, in which the reinforcement members 40 are integrated into the structure of the cowl 10. In this case, the reinforcement members 40 respectively feature an upwardly offset plateau region, which is largely realized in a plane fashion, in the transition of the channel section 11 into the extensions 12, 16.

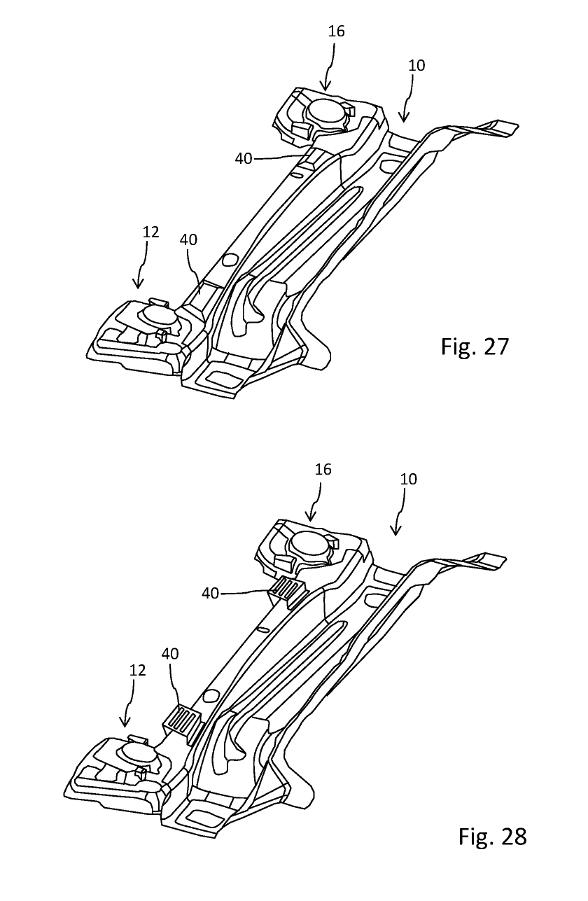

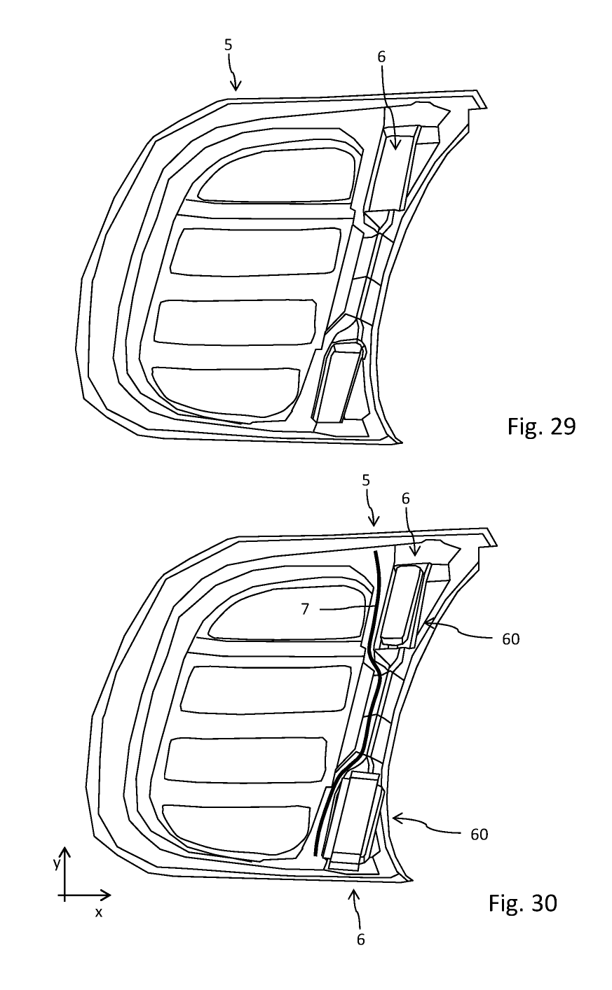

FIG. 28 shows another embodiment of the cowl 10, in which the reinforcement members 40 are realized in the form of metal clamps and integrally or frictionally mounted on the cowl 10. For example, the reinforcement members 40 may be welded on the cowl 10.

FIG. 29 shows an inner side of the hood with two reinforcement members 6 that respectively lie above the airbag arrangements 60 in the installed position. These reinforcement members are essentially realized in the form of plane depressions in the inner side of the hood 5. They are located on the left and on the right side of the hood and approximately adjacent to its rear edge that faces the windshield 4.

In the additional embodiment according to FIG. 30, the hood 5 features a separate seal 7 that extends over the hood 5 in the lateral vehicle direction (y). This seal 7 separates the reinforcement members 6 from the front region of the hood 5 referred to the driving direction. When the hood is closed, in particular, the seal 7 rests on the front edge 33 of the upper cover 30 as indicated in FIG. 2. In this way, the region or the intermediate space between the hood 5 and the cowl 10, in which the airbag arrangements 60 are located, can be sufficiently sealed relative to the engine compartment. FIG. 30 also shows the airbag arrangements 60, which are arranged on the inner side of the hood 5.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment as contemplated herein. It should be understood that various changes may be made in the function and arrangement of elements described in an exemplary embodiment without departing from the scope of the invention as set forth in the appended claims.

1-14. (canceled)

15. A motor vehicle body comprising:
a hood;
a cowl that borders on a windshield from outside; and
at least one airbag arrangement with a housing arranged between the hood and the cowl and a deployable airbag, wherein the airbag is operable to at least slightly raise a rear end of the hood away from the cowl when the airbag is deployed from the housing.

16. The motor vehicle body according to claim 15, further comprising a hood hinge configured to couple the hood to the motor vehicle body and to allow the rear end of the hood to move relative to the cowl when the airbag is deployed.

17. The motor vehicle body according to claim 16, wherein the hood hinge comprises a breakable link configured to rupture when a force on the hood from below exceeds a predefined value to allow the rear end of the hood to move relative to the cowl when the airbag is deployed.

18. The motor vehicle body according to claim 16, wherein the hood hinge is configured to remain intact for raising a front end of the hood after the breakable link has ruptured.

19. The motor vehicle body according to claim 15, further comprising a reinforcement member disposed on a side of the airbag arrangement opposite the hood.

20. The motor vehicle body according to claim 15, wherein the reinforcement member is integrated into the cowl.

21. The motor vehicle body according to claim 19, further comprising an upper cover and a lower cover for the cowl.

22. The motor vehicle body according to claim 21, wherein the reinforcement member is arranged between the upper cover and the lower cover.

23. The motor vehicle body according to claim 21, wherein the reinforcement member is arranged an upper side of the upper cover.

24. The motor vehicle body according to claim 19, wherein the reinforcement member comprising a reinforcing plate structurally connected to the cowl.

25. The motor vehicle body according to claim 19, wherein the reinforcement member is integrated into the housing of the airbag arrangement.

26. The motor vehicle body according to claim 19, wherein the airbag arrangement and the reinforcement member are disposed on the cowl.

27. The motor vehicle body according to claim 15, wherein the airbag arrangement is disposed on an underside of the hood.

28. The motor vehicle body according to claim 15, wherein the housing of the airbag arrangement comprises an elastic wall section.

29. The motor vehicle body according to claim 15, wherein the housing of the airbag arrangement comprises an opening in the direction toward the windshield.

30. The motor vehicle body according to claim 15, wherein an inner side of the hood comprises an plane reinforcement member positioned directly above the airbag arrangement in a vertical vehicle axis when the hood is in a closed position.

31. The motor vehicle body according to claim 15, further comprising a left airbag arrangement disposed directly adjacent to a left hood hinge and a right airbag arrangement disposed directly adjacent to a right hood hinge.

32. A motor vehicle comprising:
a motor vehicle body having a cowl that borders on a windshield;
a hood supported on the motor vehicle body and at least partially overlapping the cowl;
a hood hinge assembly including first and second hinges coupling the hood to the motor vehicle body;
a first airbag arrangement with a first housing disposed between the hood and the cowl adjacent the first hinge and a first airbag deployable from the first housing; and
a second airbag arrangement with a second housing disposed between the hood and the cowl adjacent the second hinge and a second airbag deployable from the housing;
wherein the hood hinge assembly is configured to allow the rear end of the hood to move relative to the cowl when at least one of the first and second airbags is deployed.

33. The motor vehicle according to claim 32, wherein each of the first and second hood hinges comprises a breakable link configured to rupture when a force on the hood from below exceeds a predefined value to allow the rear end of the hood to move relative to the cowl when the airbag is deployed.

34. The motor vehicle according to claim 32, wherein each of the first and second airbag arrangement further comprises a reinforcement member disposed on a side of the airbag arrangement opposite the hood.
